(19) United States
(12) Patent Application Publication
(10) Pub. No.: US 2014/0097136 A1
(43) Pub. Date: Apr. 10, 2014

(54) COMPOSITE MICROORGANISM REACTOR, AND APPARATUS AND METHOD FOR WATER TREATMENT USING THE SAME

(71) Applicants: Kwang Jae Woo, Daejeon (KR); Yeon Gil Kim, Daejeon (KR)

(72) Inventors: Kwang Jae Woo, Daejeon (KR); Yeon Gil Kim, Daejeon (KR)

(73) Assignee: DAEWOONG ECOSYSTEMS AND SOLUTION, Chungcheongnam-do (KR)

(21) Appl. No.: 14/119,416

(22) PCT Filed: Apr. 17, 2012
(86) PCT No.: PCT/KR2012/002913

§ 371 Date: Nov. 21, 2013

(30) Foreign Application Priority Data
Jul. 5, 2011 (KR) 10-2011-0066240
Jul. 5, 2011 (KR) 10-2011-0066241

(51) Int. Cl. C02F 3/30

(52) U.S. Cl. CPC C02F 3/301
USPC 210/605; 210/150; 210/151

(57) ABSTRACT

The present invention relates to a composite microorganism reactor, wherein both dephosphorization and denitrification occur in one reactor, and an apparatus and a method for water treatment using the same. The composite microorganism reactor according to the present invention comprises: an inner space for accommodating sewage and waste; a partition wall placed in the inner space to divide the same into an anaerobic region for dephosphorization and an anoxic region for denitrification; a sewage and waste inlet portion placed at the upper portion of the anaerobic region; a sewage and waste outlet portion placed at the upper portion of the anoxic region to discharge sewage and waste outside; a sludge discharge hole placed at the lower portion of the inner space to discharge sludge precipitated in the sewage and waste flowing into the inner space; and a sewage and waste agitation device provided at the anaerobic region to agitate the sewage and waste of the anaerobic region, wherein the sewage and waste flowing into the anaerobic region through the sewage and waste inlet portion pass through the lower end of the partition wall to flow into the anoxic region, and then rise at the anoxic region to be discharged outside through the sewage and waste outlet portion.

### BACKGROUND OF THE INVENTION

1. Field of the Invention

The present invention relates to a water treatment apparatus for processing various wastewater. More particularly, the present invention relates to a composite microorganism reactor in which both of denitrification and dephosphorization are carried out in a single reactor, and a water treatment apparatus and method using the composite microorganism reactor.

2. Description of the Related Art

Environmental pollution like soil and air contaminations and global warming is becoming increasingly serious, and the amount of sewage, wastewater or dirty water (hereinafter referred to as the “wastewater”) has been greatly increased. As a result, treatment facilities have been developed highly and the cost for processing wastewater is on the increase. Moreover, various water pollutants are not processed perfectly and can be introduced into rivers or rakes which may be used as source water. Therefore, it is difficult to manage the quality of water effectively.

The water treatment techniques for treating and purifying wastewater are divided into physicochemical treatment and biological treatment. Examples of physicochemical treatment are such methods as filtering, chemical coagulation, precipitation and oxidation treatment. In the biological treatment, various pollutants are removed by maximizing metabolic process of microorganism in a biological reactor retained the activated sludge.

The physicochemical water treatment has advantages that additional devices can be added in the existing treatment facility without big change, and the efficiency of treatment is high, but disadvantages that a large scale facility is required and a lot of by-product such as excess sludge is generated. On the other hand, biological treatment is more cost effective than the physicochemical treatment. Therefore, biological treatment is mostly used for wastewater treatment.

The ordinary activated sludge process that is the basis of wastewater treatment comprises an initial setting pond, an aerobic tank and a final setting pond. The precipitated solids included in the introduced wastewater is precipitated and removed in the initial setting pond, and the wastewater in which large impurities have been removed is transferred to the aerobic tank. In the aerobic tank, the wastewater is mixed with the activated sludge transferred by a transfer pump, and the microorganism of the mixed solution is decomposed and removed by a biochemical reaction of aerobic microbes. The mixed solution of the aerobic tank is transferred to the final setting pond to separate the solid and the liquid, the upper water is discharged, a portion of the precipitated sludge is transferred to the aerobic tank, and the rest of excess sludge is processed by a sludge treatment facility.

A water treatment method using a sequencing batch reactor SBR in which the inflowing, microbial reaction, precipitation and discharging of wastewater is carried out in a single reactor, uses a single reactor as main reactor. Thus, there is an advantage of reducing site area of wastewater treatment facilities. In addition, there is no necessity for accommodating the setting pond additionally, and labor costs can be reduced by automated facilities.

However, according to the water treatment method using the ordinary activated sludge process or the sequencing batch reactor, the removal rate of nutrient salts such as nitrogen and phosphorus is low. This nutrient salts acts as a main cause substance of eutrophication. In order to solve above described problems, further researches is being carried out to increase the removal efficiency of nitrogen and phosphorous.

For example, registered Korean Patent No. 0424060, there is disclosed an integral wastewater treatment apparatus in which a nitrification tank, a denitrification tank and a precipitation tank are formed as a one body. However, because the integral wastewater treatment apparatus has no anaerobic selector for dephosphorization, phosphorus cannot be easily removed. Further, because the apparatus is formed as a one body, it is not suitable for a large scale facility.

Registered Korean Patent No. 0397697 and 0468997, there is disclosed a wastewater treatment apparatus in which a upstream anaerobic reactor for maintaining the concentration of sludge at a high level is installed in the front end of an aerobic tank so as to remove pollutants such as non-degradable organic material, toxic material, nutritive substance and heavy metal. However, the wastewater treatment apparatus has a problem that a short circuiting or a density current can be occurred in the upstream anaerobic reactor. If short circuiting or the density current is occurred, the removal efficiency of pollutants can be reduced. The wastewater treatment apparatus has a further problem that the denitrification and the dephosphorization reactions are interfered with each other, because of having no anoxic selector for carrying out the denitrification reaction independently. The interference of the denitrification and the dephosphorization reactions reduces totally the removal efficiency of nitrogen and phosphorus.

Registered Korean Patent No. 0655471 and Korean Patent Publication No. 2010-0127984, there is disclosed a wastewater treatment apparatus having an upstream biological reactor and a rectangular upstream anaerobic/anoxic reactor for removing nutrient salts such as nitrogen and phosphorus. However, in this wastewater treatment apparatus, the denitrification process of an anaerobic mechanism and the dephosphorization process of an anoxic mechanism are carried out in a reactor which is not divided, thereby degrading total phosphorus removal efficiency.

Registered Korean Patent No. 0912562 and 0942053, there is disclosed a wastewater treatment method using a sequencing batch reactor. However, according to the wastewater treatment method, because all biological reactions are carried out in a single sequencing batch reactor, an anaerobic denitrification mechanism, the anoxic dephosphorization mechanism and the aerobic nitrification mechanism are interfered with one another, thereby degrading the removal efficiency of pollutants.

Registered Korean Patent No. 0407503, there is disclosed a wastewater treatment method using a sequencing batch process. However, according to the wastewater treatment method, because the denitrification process and the dephosphorization process are carried out in a multipurpose reactor, the denitrification mechanism and the dephosphorization mechanism are interfered with each other, thereby degrading the removal efficiency of nitrogen and phosphorus.

Registered Korean Patent No. 0563449, there is disclosed a wastewater treatment apparatus using a batch reactor to remove organic matters as well as nitrogen and phosphorus components, of wastewater. Because the wastewater treatment apparatus has a dephosphorization tank independently, the removal efficiency of phosphorus is high, but the nitrogen removal efficiency by facultative denitrification anaerobes can be degraded.

### SUMMARY OF THE INVENTION

The present invention has been proposed to solve the problem aforementioned, and it is an object of the present invention to provide a composite microorganism reactor and a water treatment apparatus and method using it, which are capable of effectively removing organic matters as well as nitrogen and phosphorus by carrying out the denitrification and the dephosphorization reactions in a reactor without interference.

In order to accomplish the objects, a composite microorganism reactor according to the present invention comprises an inner space for accommodating wastewater; a partition wall arranged in the inner space, for dividing the inner space into an anaerobic region and an anoxic region, the anaerobic region leading to dephosphorization by anaerobic mechanism of microorganism and the anoxic region leading to denitrification by anoxic mechanism of microorganism; a wastewater inflow portion arranged in the upper side of the anaerobic region to introduce the wastewater into the anaerobic region; a wastewater outflow portion arranged in the upper side of the anoxic region to discharge the wastewater outside; a sludge outlet arranged in the lower side of the inner space to discharge the sludge precipitated in the wastewater flowing into the inner space; and a wastewater agitation device installed in the anaerobic region to agitate the wastewater of the anaerobic region, wherein the wastewater introducing into the anaerobic region through the wastewater inflow portion passes through the lower end of the partition wall to be introduced into the anoxic region, and then rises in the anoxic region to be discharged outside through the wastewater outflow portion.

The composite microorganism reactor according to the present invention may further comprise a ciliary ball media assembly installed in the anoxic region and made by connecting a plurality of ciliary ball media with a connecting member, facultative denitrification anaerobes being adhered to the plurality of ciliary ball media.

It is desirable that the ciliary ball media assembly is filled in the anoxic region at 10-50 vol % of the anoxic region.

It is desirable that the ciliary ball media has 20-100 mm diameter of spherical form and 600-900 kg/m³ of the initial bulk density, and within the wastewater, 1,000±100 kg/m³ of bulk density by adhering of microorganism.

The partition wall may comprise a center partition arranged in the center of the inner space and formed as a hollow type; an upper sloped partition extended outside along the upper circumference of the center partition; and a lower sloped partition extended outside along the lower circumference of the center partition. It is desirable that the anaerobic region is provided in the inside of the partition wall and the anoxic region is provided in the outside of circumference of the partition wall.

The wastewater outflow portion may be provided in the upper circumference of the anoxic region as an overflow type.

The composite microorganism reactor according to the present invention may further comprise a bubble generating apparatus having an aeration tubes arranged in the lower side of the ciliary ball media assembly and an air supply device for supplying air to the aeration tube through an air supply tube, the bubble generating apparatus being capable of supplying the ciliary ball media assembly to bubbles and removing microorganism adhered to the ciliary ball media assembly.

The wastewater agitation device may comprise a circulating pump arranged in the lower side of the anaerobic region; a wastewater rising tube connected to the circulating pump and extended to the upper side of the anaerobic region to guide the wastewater squeeze pumped by the circulating pump to the upper side of the anaerobic region; and a wastewater lowering tube connected to the upper end of the wastewater rising tube and extended to the lower side of the anaerobic region to guide the wastewater risen along the wastewater rising tube to the lower side of the anaerobic region.

The composite microorganism reactor according to the present invention may further comprise a nitrate solution transfer tube arranged in the lower side of the anoxic region to transfer the nitrate solution of the wastewater discharged through the wastewater outflow portion to anoxic region.

In order to accomplish the objects, the water treatment apparatus according to an aspect of the present invention comprises a composite microorganism reactor having an inner space for accommodating wastewater; a sequencing batch reactor (SBR) having an aerobic tank and a sludge outlet and for executing the inflowing of wastewater, the microbial reaction, the precipitation and the discharging of wastewater in the same space, the wastewater passed through the composite microorganism reactor being flowed into the aerobic tank, the aerobic tank introducing air into the wastewater, and the sludge outlet discharging the precipitated sludge; a filter module installed in the sequencing batch reactor, the filter module filtering and discharging the wastewater of the sequencing batch reactor; and a nitrate solution transfer tank for receiving nitrate solution nitrified by executing aerobic process in the wastewater of the sequencing batch reactor, to reduce the concentration of dissolved oxygen of the nitrate solution. The composite microorganism reactor comprises a partition wall arranged in the inner space, for dividing the inner space into an anaerobic region and an anoxic region, the anaerobic region leading to dephosphorization by anaerobic mechanism of microorganism and the anoxic region leading to denitrification by anoxic mechanism of microorganism; a wastewater inflow portion arranged in the upper side of the anaerobic region to introduce the wastewater into the anaerobic region; a wastewater outflow portion arranged in the upper side of the anoxic region to discharge the wastewater of the anoxic region to the sequencing batch reactor; a sludge outlet arranged in the lower side of the inner space to discharge the sludge precipitated in the wastewater introducing into the inner space; and a wastewater agitation device installed in the anaerobic region to agitate the wastewater of the anaerobic region. The wastewater introducing into the anaerobic region through the wastewater inflow portion passes through the lower end of the partition wall to be introduced into the anoxic region, and then rises in the anoxic region to be flowed into the sequencing batch reactor through the wastewater outflow portion. The sludge discharged from the sludge outlet of the sequencing batch reactor is transferred to the anaerobic region and the nitrate solution of the nitrate solution transfer tank is transferred to the anoxic region.

In order to accomplish the objects, the water treatment apparatus according to another aspect of the present invention comprises a composite microorganism reactor having an inner space for accommodating wastewater; an aerobic tank in which the wastewater passed through the composite microorganism reactor is introduced and an aerobic device for introducing air into the wastewater is provided; a precipitation tank in which the wastewater passed through the aerobic tank is introduced, the introduced wastewater is divided into a solid and liquid, and the upper water is discharged into a river and the precipitated sludge is discharged through a sludge discharge tube; and a nitrate solution transfer tube for transferring the nitrate solution nitrified by executing aerobic process in the wastewater of the aerobic tank, to the composite microorganism reactor. The composite microorganism reactor comprises a partition wall arranged in the inner space, for dividing the inner space into an anaerobic region and an anoxic region, the anaerobic region leading to dephosphorization by anaerobic mechanism of microorganism and the anoxic region leading to denitrification by anoxic mechanism of microorganism; a wastewater inflow portion arranged in the upper side of the anaerobic region to introduce the wastewater into the anaerobic region; a wastewater outflow portion arranged in the upper side of the anoxic region to discharge the wastewater of the anoxic region to the aerobic tank; and a wastewater agitation device installed in the anaerobic region to agitate the wastewater of the anaerobic region. The wastewater introducing into the anaerobic region through the wastewater inflow portion passes through the lower end of the partition wall to be introduced into the anoxic region, and then rises in the anoxic region to be flowed to the aerobic tank through the wastewater outflow portion. The nitrate solution transferred through the nitrate solution transfer tube is transferred to the anoxic region. A portion of the sludge discharged from the sludge outlet of the precipitation tank is transferred to the anaerobic region of the composite microorganism reactor.

In order to accomplish the objects, the water treatment method according to an aspect of the present invention comprises the steps of: (a) inflowing wastewater into a composite microorganism reactor whose inner space is divided into an anaerobic region and an anoxic region by a partition wall, the anaerobic region leading to dephosphorization by anaerobic mechanism of microorganism and the anoxic region leading to denitrification by anoxic mechanism of microorganism, wherein the wastewater is introduced into the anaerobic region through a wastewater inflow portion arranged in the upper side of the anaerobic region and then flowed into the anoxic region through the lower end of the partition wall; (b) inflowing the wastewater discharged from a wastewater outflow portion arranged in the upper side of the anoxic region into the sequencing batch reactor; (c) introducing the nitrate solution nitrified by executing aerobic process in the wastewater of the sequencing batch reactor into the nitrate solution transfer tank to reduce the concentration of dissolved oxygen of the nitrate solution; (d) transferring the nitrate solution of the nitrate solution transfer tank to the anoxic region of the composite microorganism tank; (e) transferring the sludge precipitated in the sequencing batch reactor to the anaerobic region of the composite microorganism tank; (f) discharging the sludge precipitated in the composite microorganism tank outside; and (g) discharging the wastewater processed in the sequencing batch reactor outside.

In order to accomplish the objects, the water treatment method according to another aspect of the present invention comprises the steps of: (a) inflowing wastewater into a composite microorganism reactor whose inner space is divided into an anaerobic region and an anoxic region by a partition wall, the anaerobic region leading to dephosphorization and the anoxic region leading to denitrification, wherein the wastewater is introduced into the anaerobic region through a wastewater inflow portion arranged in the upper side of the anaerobic region and then flowed into the anoxic region through the lower end of the partition wall; (b) inflowing the wastewater discharged from a wastewater outflow portion arranged in the upper side of the anoxic region into the aerobic tank; (c) transferring the nitrate solution nitrified by executing aerobic process in the wastewater of the aerobic tank to the anoxic region of the composite microorganism tank; (d) precipitating and filtering the wastewater processed in the aerobic tank, which is introduced into a precipitation tank; (e) transferring the sludge precipitated in the precipitation tank to the anaerobic region of the composite microorganism tank; and (f) discharging the wastewater processed in the precipitation outside.

The water treatment apparatus according to the present invention has the composite microorganism reactor installed in the upstream of a main reactor, and the composite microorganism reactor has an anaerobic region for leading to dephosphorization by anaerobic mechanism of microorganism and the anoxic region for leading to denitrification by anoxic mechanism of microorganism, thereby increasing the removal efficiency of organic matters as well as nitrogen and phosphorus components, of wastewater.

In addition, the composite microorganism reactor according to the present invention is divided into the anaerobic region and the anoxic region by a partition wall so that the dephosphorization reaction and the denitrification reaction are not interfered each other in the composite microorganism reactor. Therefore, it is possible to remove stably nitrogen and phosphorus.

In addition, according to the water treatment apparatus of the present invention, the wastewater introduced into the composite microorganism reactor is flowed downward in the anaerobic region and flowed upward in the anoxic region. Therefore, the retention time of wastewater is increased in the composite microorganism reactor to obtain sufficient microorganism mechanism and prevent the short circuiting from occurring.

In addition, according to the water treatment apparatus of the present invention, a ciliary ball media assembly capable of inhabiting the denitrification microorganism is arranged in the anoxic region of the composite microorganism reactor. Thus, it is possible to prevent the denitrification microorganism from discharging, thereby increasing the removal efficiency of nitrogen.

In addition, according to the water treatment apparatus of the present invention, the transfer pathway of sludge for denitrification is provided apart from the transfer pathway of nitrate solution containing much nitrate nitrogen NO₃—N, and the sludge is transferred to the anaerobic region of the composite microorganism reactor, thereby improving the removal efficiency of phosphorus.

In addition, according to the water treatment apparatus of the present invention, the agitation device is installed in the anaerobic region of the composite microorganism reactor and the ciliary ball media assembly is installed in the anoxic region of the composite microorganism reactor so that the MLSS concentration that is the activated microorganism concentration can be maintained highly. In case that the composite microorganism reactor is operated in high MLSS concentration, the water treatment apparatus is highly resistant to the flow change or shock loads, and maintains high dephosphorization and denitrification efficiency even in the wintertime.

In addition, according to the composite microorganism reactor of the present invention, the anaerobic region and the anoxic region are arranged together to form as one body. Therefore, new installation and maintenance are easy.

In addition, according to the composite microorganism reactor of the present invention can be installed in the existing wastewater treatment apparatus by simple pathway change. Therefore, it is possible to improve easily the existing wastewater treatment apparatus without changing the structure.

### BRIEF DESCRIPTION OF THE DRAWINGS

FIG. 1 is a flow sheet showing the wastewater treatment processes of a water treatment apparatus according to a first embodiment of the present invention.

FIG. 2 is a top view schematically showing a water treatment apparatus according to a first embodiment of the present invention.

FIG. 3 is a cross sectional view schematically showing a composite microorganism tank of a water treatment apparatus according to a first embodiment of the present invention.

FIG. 4 is a cross sectional view schematically showing a sequencing batch reactor of a water treatment apparatus according to a first embodiment of the present invention.

FIG. 5 is a picture showing an example of a ciliary ball media assembly provided in a water treatment apparatus according to a first embodiment of the present invention.

FIG. 6 is a surface picture (a) and a cross sectional picture (b) showing ciliary ball media of a ciliary ball media assembly shown in FIG. 5.

FIG. 7 is a flow sheet showing the wastewater treatment processes of a water treatment apparatus according to a second embodiment of the present invention.

FIG. 8 is a top view schematically showing a water treatment apparatus according to a second embodiment of the present invention.

FIG. 9 is a top view schematically showing a water treatment apparatus according to a third embodiment of the present invention.

FIG. 10 is a top view schematically showing a water treatment apparatus according to a forth embodiment of the present invention.

### DETAILED DESCRIPTION OF THE INVENTION

Hereinafter, the present invention will be described by way of examples illustrating best mode embodiments. Examples described below are only for illustrative purposes. Therefore, the scope of the present invention is limited only by the scope of the claims, but not to the examples.

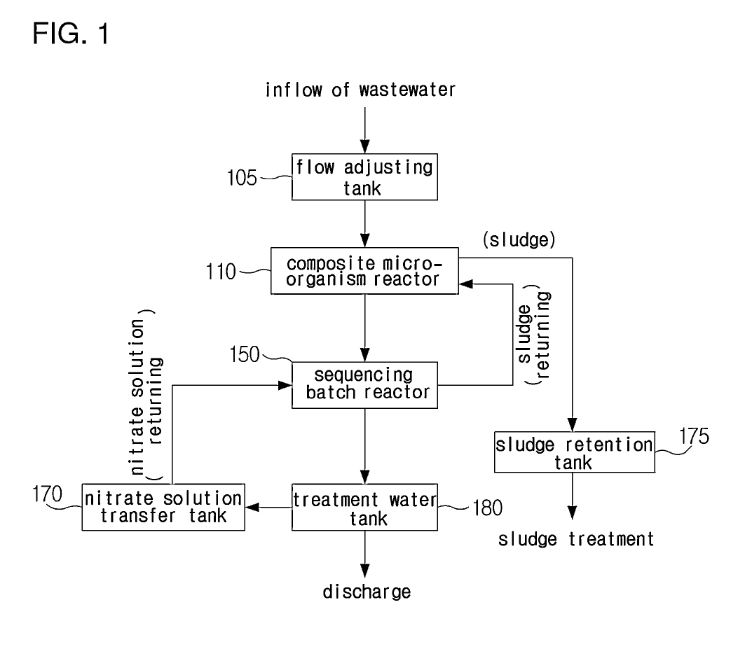

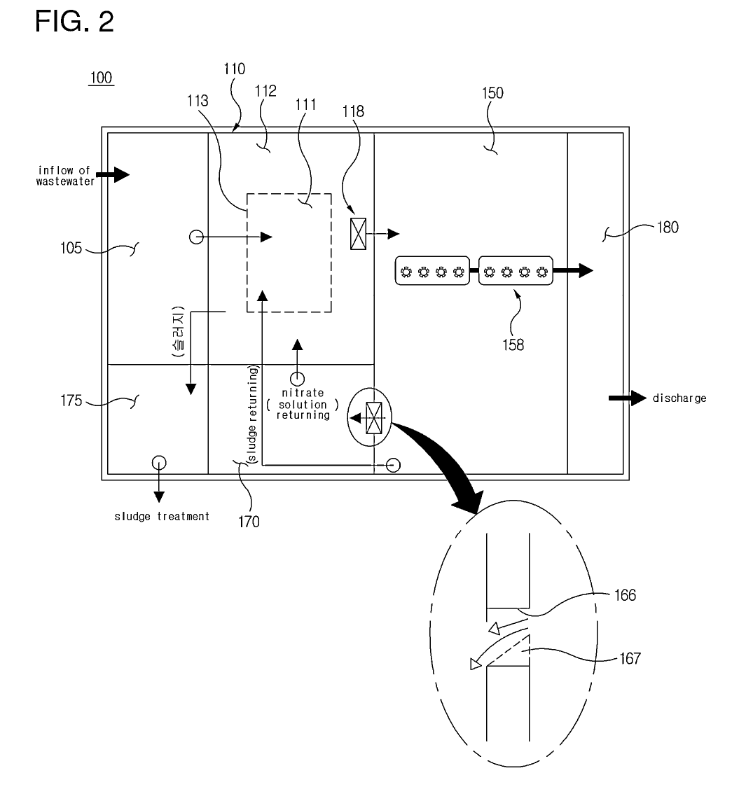

FIG. 1 is a flow sheet showing the wastewater treatment processes of a water treatment apparatus according to a first embodiment of the present invention, and FIG. 2 is a top view schematically showing a water treatment apparatus according to a first embodiment of the present invention.

As shown FIGS. 1 and 2, the water treatment apparatus 100 according to the first embodiment of the present invention includes a flow adjusting tank 105 for temporarily storing wastewater introduced; a composite microorganism reactor 110 having a anaerobic region 111 and anoxic region 112; a sequencing batch reactor (SBR) 150 for executing the inflowing of wastewater, the microbial reaction, the precipitation and the discharging of wastewater in the same space; a nitrate solution transfer tank 170 for receiving nitrate solution discharged from the sequencing batch reactor to reduce the concentration of dissolved oxygen of the nitrate solution; a sludge retention tank 175 for accommodating the sludge discharged from the composite microorganism reactor 110; and a treatment water tank 180 for storing the treatment water finally processed in the sequencing batch reactor 150.

Pathways or pipes for transferring wastewater or sludge are installed between the flow adjusting tank 105 and the composite microorganism reactor 110, the composite microorganism reactor 110 and the sequencing batch reactor 150, the composite microorganism reactor 110 and the nitrate solution transfer tank 170, the composite microorganism reactor 110 and the sludge retention tank 175, the sequencing batch reactor 150 and the nitrate solution transfer tank 170, and the sequencing batch reactor 150 and the treatment water tank 180. Particularly, in the pathway 166 between the sequencing batch reactor 150 and the nitrate solution transfer tank 170, a whirlpool prevention device 167 is installed to prevent whirlpool of the nitrate solution, which is flowed from the sequencing batch reactor 150 to the nitrate solution transfer tank 170, from occurring.

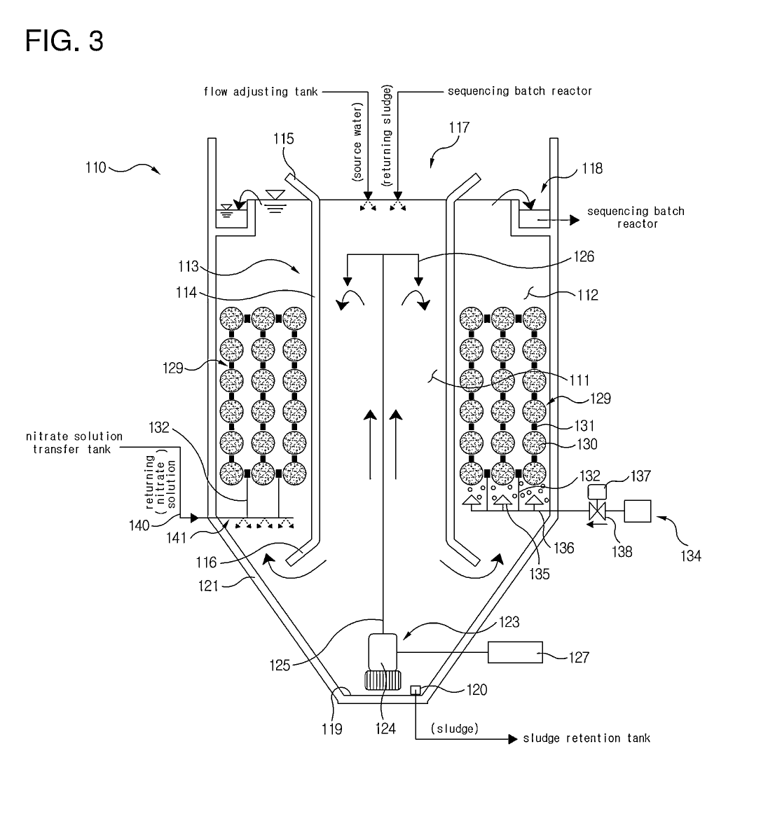

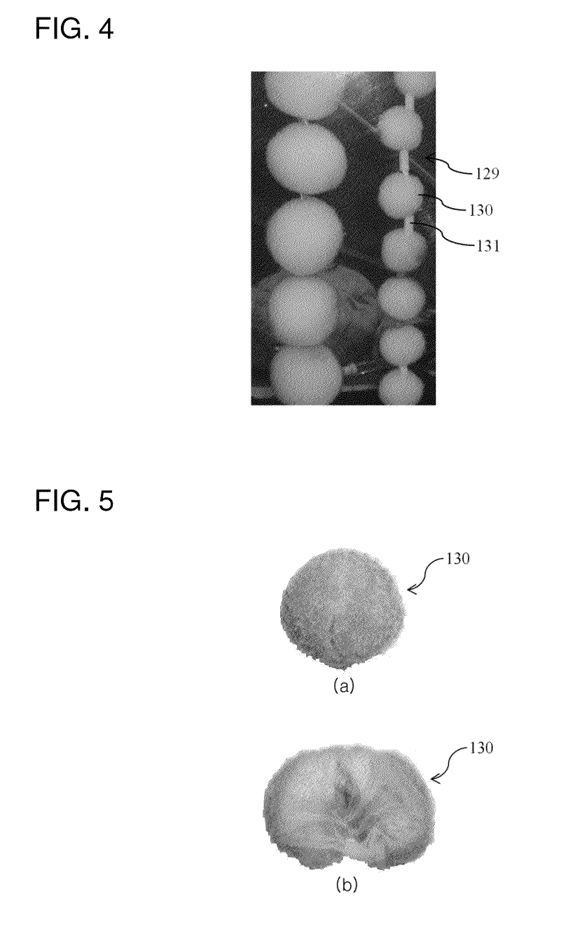

FIG. 3 is a cross sectional view showing a composite microorganism tank of a water treatment apparatus according to a first embodiment of the present invention.

Referring to FIG. 3, the composite microorganism reactor 110 includes a partition wall 113 arranged in the inner space of the composite microorganism reactor 110, for dividing the inner space into an anaerobic region 111 and an anoxic region 112; a wastewater inflow portion 117 arranged in the upper side of the anaerobic region 111; a wastewater outflow portion 118 arranged in the upper side of the anoxic region 112; a sludge pit 119 arranged in the lower side of the inner space; a wastewater agitation device 123 installed in the anaerobic region 111 to agitate the wastewater of the anaerobic region 111; a ciliary ball media assembly 129 installed in the anoxic region 112; and a bubble generating apparatus 134 installed in the lower side of the ciliary ball media assembly 129. The wastewater inflowed from the flow adjusting tank 105 into the composite microorganism reactor 110, is introduced into the anaerobic region 111 through the wastewater inflow portion 117, and then passed through the anoxic region 112 and inflowed into the sequencing batch reactor 150 through the wastewater outflow portion 118.

In the anaerobic region 111, the phosphorus (PO₄—P) is released by anaerobic mechanism of microorganism to cause dephosphorization reaction, and in the anoxic region 112, the nitrate nitrogen (NO₃—N) and nitrite nitrogen (NO₂—N) are reduced into nitrogen gas (N₂) by anoxic mechanism of microorganism to cause denitrification reaction. Because the anaerobic region 111 and the anoxic region 112 are divided by the partition wall 113, there is no interference between the dephosphorization reaction of the anaerobic region 111 and the denitrification reaction of the anoxic region 112.

The partition wall 113 is formed as a hollow type and opened its both ends. The partition wall 113 includes a center partition 114 arranged in the center of the inner space, an upper sloped partition 115 extended outside along the upper circumference of the center partition 114, and a lower sloped partition 116 extended outside along the lower circumference of the center partition 114. The top of the upper sloped partition 115 is arranged higher than the maximum water level of the anoxic region 112, and the lower sloped partition 116 is arranged higher than the sludge outlet 120 provided in the sludge pit 119 to discharge sludge. The anaerobic region 111 is provided in the inside of the partition wall 113, and the anoxic region 112 is provided between the partition wall 113 and the outer wall 121 of the composite microorganism reactor 110 to surround the anaerobic region 111.

The wastewater inflow portion 117 for introducing wastewater into the anaerobic region 111 is arranged in the inside of the upper sloped partition 115. Through the wastewater inflow portion 117, the wastewater passed through the flow adjusting tank 105 and the sludge returned from the sequencing batch reactor 150 are introduced into the anaerobic region 111. The wastewater introduced into the anaerobic region 111 is descended to the lower end of the partition wall 113 and introduced into the anoxic region 112 through a gap between the lower sloped partition 116 and the outer wall 121.

In addition the wastewater passed through the anaerobic region 111, the nitrate solution from the nitrate solution transfer tank 170 is introduced into the anoxic region 112. For this, the anoxic region 112 is connected to the nitrate solution transfer tube 140 connected with the nitrate solution transfer tank 170, and the nitrate solution transferring along the nitrate solution transfer tube 140 is dispersed into the anoxic region 112 through a nitrate solution dispersion portion 141 of the nitrate solution transfer tube 140 arranged in the lower side of the anoxic region 112. The wastewater is risen within the anoxic region 112 and discharged to the sequencing batch reactor 150, through the wastewater outflow portion 118 provided in the upper side of the anoxic region 112. The wastewater outflow portion 118 is provided in the upper circumference of the anoxic region 112 as an overflow type.

The wastewater agitation device 123 agitates wastewater such that dephosphorization reaction of microorganism is executed in the whole anaerobic region 111. Particularly, The wastewater agitation device 123 raises the wastewater in the lower side of the anaerobic region 111 to the upper side of the partition wall 113 such that the sludge included in the wastewater is dispersed into the whole anaerobic region 111. The wastewater agitation device 123 includes a circulating pump 124 arranged in the lower side of the anaerobic region 111; a wastewater rising tube 125 connected to the circulating pump 124 and extended to the upper side of the anaerobic region 111 to guide the wastewater squeeze pumped by the circulating pump 124 to the upper side of the anaerobic region 111; and a wastewater lowering tube 126 connected to the upper end of the wastewater rising tube 125 and extended to the lower side of the anaerobic region 111 to guide the wastewater risen along the wastewater rising tube 125 to the lower side of the anaerobic region 111. A RPM inverter 27 controls the circulating pump 124 to adjust the revolutions of the circulating pump 124, so that the optimum agitation velocity can be obtained.

The ciliary ball media assembly 129 includes a plurality of ciliary ball media 130 and a connecting member 131. The ciliary ball media assembly 129 is suspended to fix in lower side of the anoxic region 112 by a fixing member 132. The plurality of ciliary ball media 130 are connected vertically or horizontally by the connecting member 131. As shown the drawings, in case that the plurality of ciliary ball media 130 are connected vertically, it is advantageous to prevent short circuiting or un-uniformity from occurring, which hinders uniform residence distribution of wastewater. On the other hand, in case that the plurality of ciliary ball media 130 are connected horizontally, it is advantageous to make biological slime filtration tank by frequently contacting with the activated microorganism and remove foreign material adhered to the ciliary ball media 130 by using bubbles.

As shown FIG. 5, the ciliary ball media 130 has a cilium structure. The inside and outside of the ciliary ball media 130 is made of 100% of cirrus so that all microorganisms of wastewater are well adhered and inhabitable. The outside of the ciliary ball media 130 is inhabitable for aerobic microorganism, and the inside of the ciliary ball media 130 is inhabitable for facultative microorganism. Therefore, using the ciliary ball media 130, it is effective for organic matter decomposition and nitrification by aerobic microorganism, and for denitrification and dephosphorization by facultative microorganism.

It is desirable that the material of cilium that forms the ciliary ball media 130 is synthetic resin that doesn't erode and decompose in wastewater. And it is desirable that the initial bulk density of the ciliary ball media 130 is 600-900 kg/m³. In wastewater, it is advantageous that the bulk density of the ciliary ball media 130 maintains at 1,000±100 kg/m³, which is close to the density of water (1,000 kg/m³), by adhering and inhabitation of microorganism. When the ciliary ball media 130 has above bulk density characteristics, it is advantageous for installation and management as well as the inhabitation of microorganism.

It is desirable that the ciliary ball media 130 has 20-100 mm diameter of spherical form. If the diameter of the ciliary ball media 130 is below 20 mm, the number of inhabitable microorganism is small, but being over 100 mm, the number of permeable microorganism is small, and therefore these are not effective. The ciliary ball media 130 can be formed unlike the spherical shape. However, in case of the spherical shape, microorganism is uniformly dispersed into the whole inside and outside of the ciliary ball media 130.

If the microorganism is excessively adhered to the ciliary ball media 130 arranged in wastewater so that the concentration of the activated microorganism is over a predetermined value, for example MLSS concentration more than 20,000 mg/L, and the bulk density of the ciliary ball media 130 is over a predetermined size, for example 1,100 kg/m³, the ciliary ball media 130 can be sank. In order to prevent this, the bubble generating apparatus 134 supplies bubbles to the ciliary ball media 130 so that the microorganism adhered excessively to the ciliary ball media 130 is removed from the ciliary ball media 130.

The bubble generating apparatus 134 includes a plurality of aeration tubes 135 arranged in the lower side of the ciliary ball media assembly 129; an air supply device 137 for supplying air to the aeration tubes 135 through an air supply tube 136; and a air control valve 138 installed in the air supply tube 136, for opening and closing an air pathway of the air supply tube 136. The bubble generating apparatus 134 makes bubbles through the aeration tubes 135 to supply to the ciliary ball media assembly 129, so that microorganism or foreign matter adhered to the ciliary ball media assembly 129 can be removed.

In the present invention, the detailed structure of the composite microorganism reactor 110 is not limited to this disclosure but changed variously. For example, in the inner space of the composite microorganism reactor 110, the anaerobic region 111 and the anoxic region 112 are arranged in various arrangements, according to the structure of the partition wall 113. Further, the structure of the wastewater outflow portion 118 is not limited to the overflow type but changed a different structure.

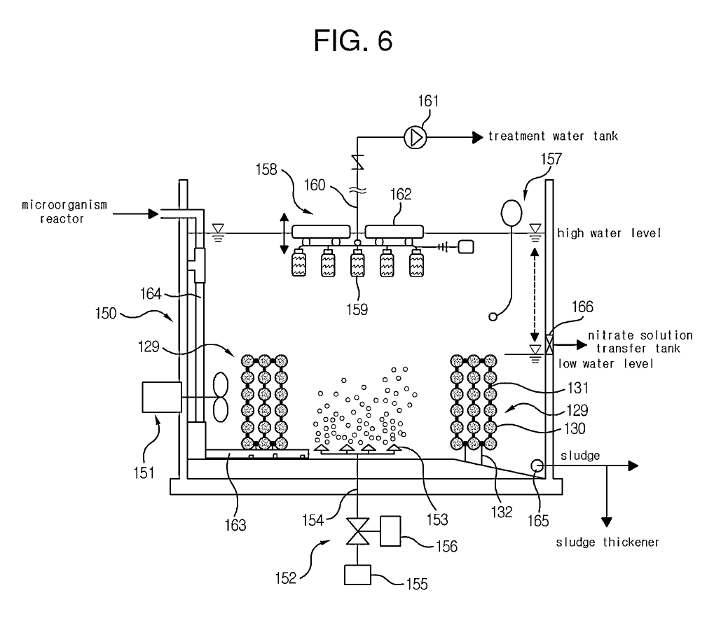

FIG. 6 is showing a sequencing batch reactor 150 of the wastewater treatment apparatus 100 according to a first embodiment of the present invention. The wastewater passed through the composite microorganism reactor 110 is introduced to the sequencing batch reactor 150 in which executes the inflowing of wastewater, the microbial reaction, the precipitation and the discharging of wastewater in the same space. Using the sequencing batch reactor 150, the area for constructing the water treatment apparatus 100 is reduced, there is no need to provide a precipitation pond, the convenience of operation can be high, and labor costs can be reduced.

The sequencing batch reactor 150 includes a agitation device 151 for agitating the wastewater in the sequencing batch reactor 150, an aerobic device 152 for supplying air into the wastewater of the sequencing batch reactor 150, a ciliary ball media assembly 129 for supporting microorgainsm, a water level detection device 157 for detecting the water level of the sequencing batch reactor 150, and a filter module 158 for discharging the wastewater of the sequencing batch reactor 150 into a treatment water tank 180. The aerobic device 152 includes a plurality of aeration tube 153 arranged in the wastewater of the sequencing batch reactor 150, an air supply device 155 for supplying air to the aeration tube 153 through an air supply tube 154 connected to the aeration tube 153, and an air control valve 156 installed in the air supply tube 154.

As above described, the ciliary ball media assembly 129 is suspended to fix in lower side of the sequencing batch reactor 150 by a fixing member 132. In case that the ciliary ball media assembly 129 is installed in the sequencing batch reactor 150, aerobic microorganism and facultative microorganism are adhered and inhabited in the ciliary ball media 130. This can prevent the microorganisms being outflowed from the sequencing batch reactor 150. The concentration of MLSS can be maintained highly compared with the conventional apparatus, so that the sequencing batch reactor 150 is resistant to shock loads. It is desirable the ciliary ball media assembly 129 is arranged below the lower water level of the sequencing batch reactor 150.

The filter module 158 includes a plurality of filters 159 for separating and filtering pollutants, a suction tube 160 connected to the filters 159, a suction pump 161 for supplying suction force to the filters 159, and a differential pressure detector, the suction pump being connected with the main pump to generate suction force, and a plurality of floating body 162 for floating to the space of the water by buoyancy and placing the filers 159 in the upper side of wastewater. The filter module 158 filters only the upper water that has low pollutant concentration in the wastewater flowed into the sequencing bath reactor 150, and discharges to the treatment water tank 180.

The wastewater passed through the composite microorganism tank 110 is introduced into the inside of the sequencing bath reactor 150. The sequencing bath reactor 150 has a dispersion tube 163 connected to a guide tube of the composite microorganism tank 110, so that the wastewater discharged from the composite microorganism tank 110 is flowed into the lower side of the sequencing bath reactor 150 through the dispersion tube 163. A series of processes, the agitation of wastewater by an agitation device 151, the aeration by an aerobic device 152, the precipitation and the discharge, are carried out in the sequencing bath reactor 150, thereby removing pollutants such as organic matter, suspended solids, nitrogen and phosphorus. The sludge precipitated in the sequencing bath reactor 150 is discharged through the sludge outlet 165 in the lower side of the sequencing bath reactor 150. A portion of the sludge is transferred to the anaerobic region 111 of the composite microorganism tank 110 and the rest of sludge is transferred to a sludge retention tank 175.

On the other hand, according to the conventional wastewater treatment apparatus using a sequencing batch reactor, all microorganism processes such as an organic matter decomposition process, a nitrification (aerobic) process, a denitrification (anoxic) process and a dephosphorization (anaerobic) process are carried out in a single sequencing batch reactor to interfere with one another, thereby degrading the removal efficiency of pollutants. For example, high dissolved oxygen according to the aerobic process 110 acts as a discouragement in the denitrification and dephosphorization process, and nitrate nitrogen NO₃—N of nitrate solution according to the nitrification process acts as a discouragement in the dephosphorization process.

According to the above described present invention, the problems can be solved by installing the composite microorganism reactor 110 in the upstream of the sequencing batch reactor 50, and the removal efficiency of nitrogen and phosphorous can be increased as well as that of organism.

Hereinafter, the water treatment method using the water treatment apparatus according to the present invention will described in detail.

First, wastewater is introduced into the flow adjusting tank 105 and temporarily stored therein. And then, the wastewater is flowed into the composite microorganism reactor 110 intermittently or sequentially. The wastewater passes through the anaerobic region 111 and the anoxic region 112 of the composite microorganism reactor 110, and flows into the sequencing batch reactor 150. In the sequencing batch reactor 150, the agitation, aerobic, precipitation and discharge processes are carried out to remove organic matter, suspended solids, nitrogen and phosphorus.

A portion of sludge precipitated in the sequencing batch reactor 150 is transferred to the anaerobic region 111 of the composite microorganism reactor 110 to carry out denitrification, and the rest of sludge is pulled out to the sludge retention tank 175 and discharged outside after sludge retention time (SRT). The upper water of the sequencing batch reactor 150 filtered by the precipitation process is transferred to the water treatment tank 180 through the filter module 158, and discharged outside.

In this wastewater processing, the wastewater of the sequencing batch water 150 is nitrified by the aerobic process, and the nitrified nitrate solution is transferred to the nitrate solution transfer tank 170. The transferred nitrate solution is stayed in the nitrate solution transfer tank 170 for a while to loss dissolved oxygen DO. Thus, the nitrate solution becomes to have low concentration of dissolve oxygen and high concentration of nitrate nitrogen NO₃—N or nitrite nitrogen NO₂—N, and to transfer to the anoxic region 112 of the composite microorganism reactor 110. The nitrate nitrogen NO₃—N or nitrite nitrogen NO₂—N of the anoxic region 112 is reduced to nitrogen gas N₂ by facultative denitrification anaerobes inhabited in the ciliary ball media 130, so that nitrogen pollution matters are removed from the wastewater. In this case, the oxygen of the wastewater or sludge from the anaerobic region 111 is utilized as carbon source required for denitrification.

On the other hand, the microorganism transferred from the sequencing batch reactor 150 to the anaerobic region 110 of the composite microorganism reactor 110 leads to the release of phosphorus by the anaerobic mechanism having no oxygen, and returned to the sequencing batch reactor 150. And then, the microorganism leads to luxury phosphorus uptake in the aerobic process of the sequencing batch reactor 150. Thus, phosphorus pollutants are finally removed in the state of excess sludge.

The nitrate nitrogen NO₃—N of nitrate solution which disturbs the phosphorus release mechanism is transferred to the anoxic region 112 of the composite microorganism reactor 110 not to influence negatively the phosphorus release mechanism in the anaerobic region 111.

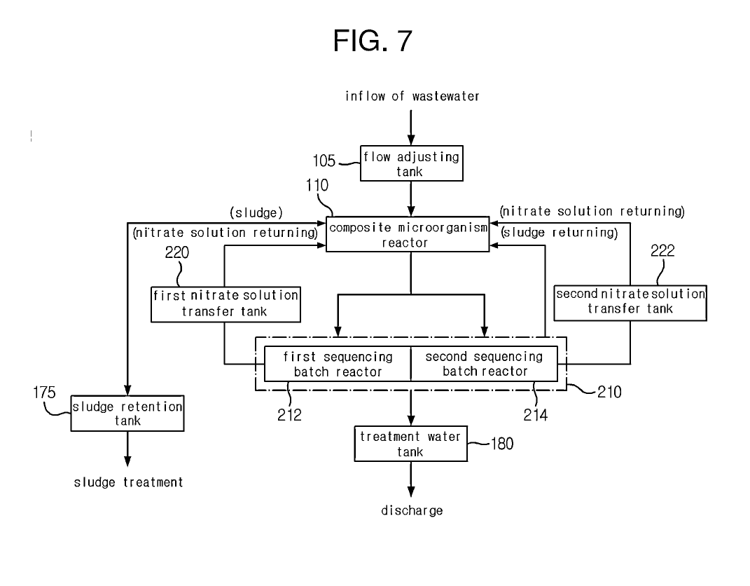

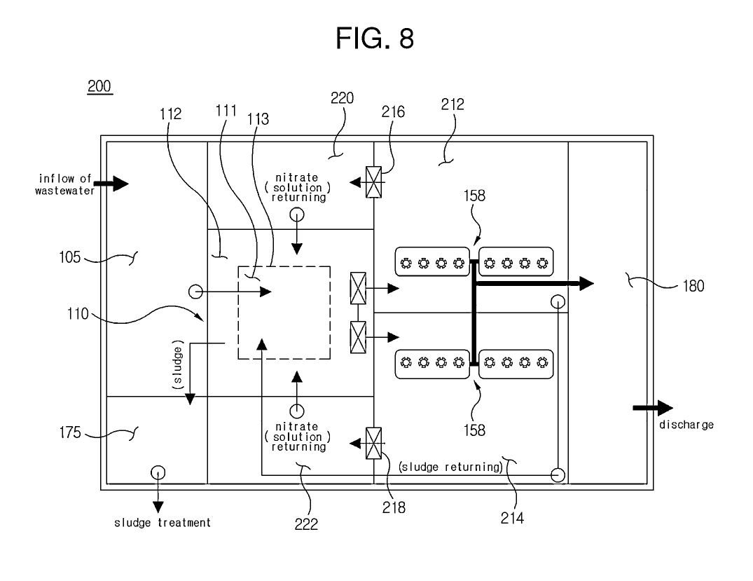

On the other hand, FIG. 7 is a flow sheet showing the wastewater treatment processes of a water treatment apparatus according to a second embodiment of the present invention, and FIG. 8 is a top view schematically showing a water treatment apparatus according to a second embodiment of the present invention.

Referring the FIGS. 7 and 8, the water treatment apparatus 200 according to the second embodiment of the present invention is a semi-batch type or a semi-continuous type of wastewater treatment apparatus in which a main reaction process uses an alternating batch reactor 210 having two batch reactors 212 and 214. The water treatment apparatus according to the second embodiment of the present invention includes a flow adjusting tank 105, a composite microorganism reactor 110, an alternating batch reactor 210, two nitrate solution transferring tanks 220, 222, a treatment water tank 180 and a sludge retention tank 175.

The water treatment apparatus according to the second embodiment of the present invention is the same constitutions as the apparatus according to the first embodiment except that two of the batch reactors 212 and 214 and two of nitrate solution transferring tanks 220, 222 are provided. The first batch reactor 212 is connected to the first nitrate solution transferring tank 220 through a pathway 213, and the second batch reactor 214 is connected to the second nitrate solution transferring tank 222 through a pathway 218.

The first batch reactor 212 and the second batch reactor 214 have filter modules 158 for filtering the upper water of wastewater, respectively. Two filter modules 158 installed in the first batch reactor 212 and the second batch reactor 212 can be operated alternatively and, as the case may be, used to share the suction device 161 (see the FIG. 6).

The drawings show two of the batch reactors 212 and 214 and two of the nitrate solution transferring tanks 220 and 222, but the number of the batch reactors and the nitrate solution transferring tanks are changed variously. And according to the number of the batch reactors, the number of the filter module 158 is changed.

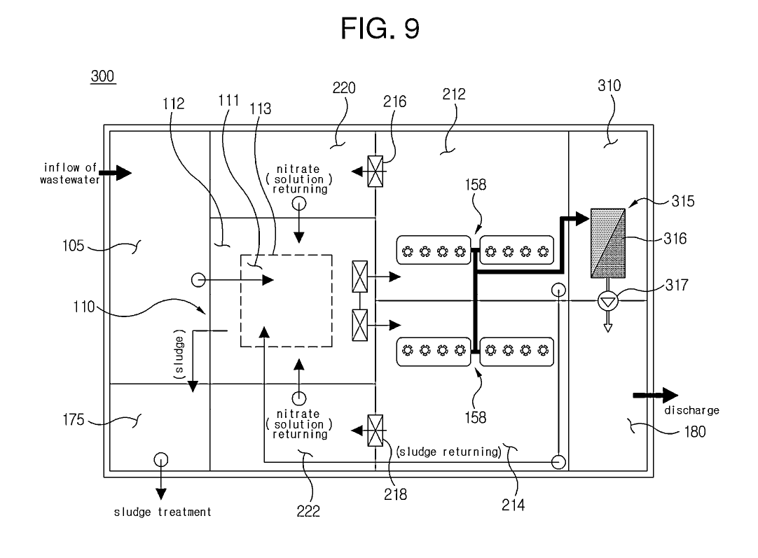

FIG. 9 is a top view schematically showing a water treatment apparatus 300 according to a third embodiment of the present invention.

The water treatment apparatus 300 according to a third embodiment of the present invention is the same constitutions as the apparatus 200 according to the second embodiment except that a filtration tank 310 is arranged between the alternating batch reactor 210 and the treatment water tank 180. The filtration tank 310 has a filtration device 315 for separating and filtering micro-pollution particles of wastewater. The filtration device 315 includes a filtration body 316 and a suction pump 317 for providing suction force to the filtration body 316.

In the water treatment apparatus 300 according to a third embodiment of the present invention, the filtration device 315 separates and filters the micro-pollution particles of the treatment water passed through the alternating batch reactor 210 so that the introduced wastewater can be purified to a gray water quality.

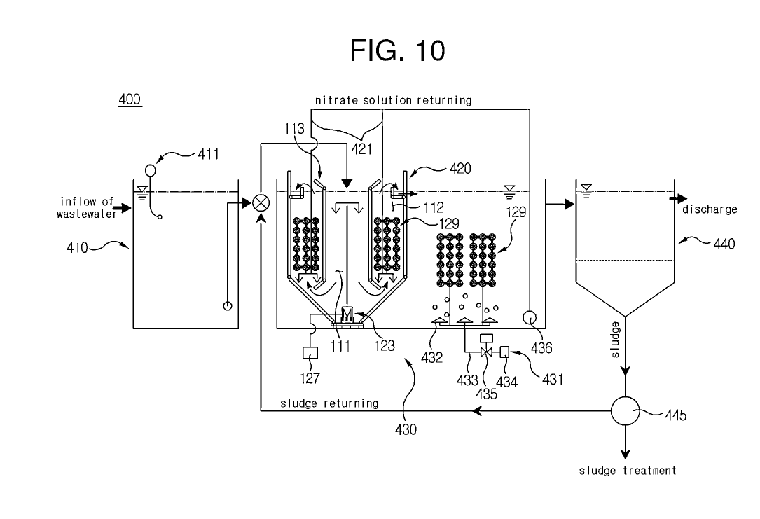

FIG. 10 shows schematically a water treatment apparatus 400 according to a forth embodiment of the present invention.

The water treatment apparatus 400 according to the forth embodiment of the present invention uses the ordinary activated sludge process that is the basis of wastewater treatment and includes a flow adjusting tank 410, a composite microorganism reactor 420, an aerobic tank 430 and a precipitation tank 440. The flow adjusting tank 410 has a water level detection device 411, and the aerobic tank 430 has an aerobic device 431 for supplying air into wastewater, a ciliary ball media assembly 129 for supporting microorganism and a return pump 436 of nitrate solution. The aerobic device 431 includes 432 a plurality of aeration tubes 432, an air supply device 434 for supplying air to the aeration tubes 432 through an air supply tube 433 connected to the aeration tubes 432; and a air control valve 435 installed in the air supply tube 433. The ciliary ball media assembly is the same as above described, and accordingly a detailed description is omitted.

The composite microorganism reactor 420 is the same as the above described composite microorganism reactor 420 except for the installation structure of the nitrate solution returning tube 421 and the bubble generation device 134. The composite microorganism reactor 420 is installed such that to precipitate in the wastewater of the aerobic tank 430. Alternatively, the composite microorganism reactor 420 can be installed in the outside of the aerobic tank 430.

In the water treatment apparatus 400 according to the forth embodiment of the present invention, the composite microorganism reactor 420 is precipitated simply in the conventional aerobic tank 430, the nitrate solution nitrified in the aerobic tank 430 is transferred to the anoxic region 112 of the composite microorganism reactor 420, and the activated sludge precipitated in the lower side of the precipitation tank 440 is transferred to the anaerobic region 111 of the composite microorganism reactor 420 by the sludge pump 445. Therefore, it improves greatly the removal efficiency of nitrogen and phosphorus.

In the water treatment apparatus 400 according to the forth embodiment of the present invention, the ciliary ball media assembly 129 is suspended in the aerobic tank 420 so that the nitrification rate can be increased by microorganism.

In the wastewater treatment apparatus according to the present invention, the composite microorganism reactor 420 having the anaerobic region 111 and the anoxic region 112 is installed between the flow adjusting tank 410 and the aerobic tank 430. Therefore, the wastewater treatment apparatus according to the present invention has higher removal efficiency of nitrogen and phosphorus than that of the wastewater treatment apparatus using the conventional ordinary activated sludge process. Further, in case that the composite microorganism reactor 420 is added to the conventional wastewater treatment apparatus which uses the ordinary activated sludge process as a main process, the water treatment facilities can be advanced without changing the structure of the conventional wastewater treatment apparatus.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A composite microorganism reactor comprising:
an inner space for accommodating wastewater;
a partition wall arranged in the inner space, for dividing the inner space into an anaerobic region and an anoxic region, the anaerobic region leading to dephosphorization by anaerobic mechanism of microorganism and the anoxic region leading to denitrification by anoxic mechanism of microorganism;
a wastewater inflow portion arranged in the upper side of the anaerobic region to introduce the wastewater into the anaerobic region;
a wastewater outflow portion arranged in the upper side of the anoxic region to discharge the wastewater outside;
a sludge outlet arranged in the lower side of the inner space to discharge the sludge precipitated in the wastewater flowing into the inner space; and
a wastewater agitation device installed in the anaerobic region to agitate the wastewater of the anaerobic region,
wherein the wastewater introducing into the anaerobic region through the wastewater inflow portion passes through the lower end of the partition wall to be introduced into the anoxic region, and then rises in the anoxic region to be discharged outside through the wastewater outflow portion.

2. The reactor according to claim 1, further comprising a ciliary ball media assembly installed in the anoxic region and made by connecting a plurality of ciliary ball media with a connecting member, facultative denitrification anaerobes being adhered to the plurality of ciliary ball media.

3. The reactor according to claim 2, wherein the ciliary ball media assembly is filled in the anoxic region at 10-50 vol % of the anoxic region.

4. The reactor according to claim 2, wherein the ciliary ball media has 20-100 mm diameter of spherical form and 600-900 kg/m³ of the initial bulk density, and within the wastewater, 1,000±100 kg/m³ of bulk density by adhering of microorganism

5. The reactor according to claim 1, wherein the partition wall comprises a center partition arranged in the center of the inner space and formed as a hollow type; an upper sloped partition extended outside along the upper circumference of the center partition; and a lower sloped partition extended outside along the lower circumference of the center partition, and the anaerobic region is provided in the inside of the partition wall and the anoxic region is provided in the outside of circumference of the partition wall.

6. The reactor according to claim 5, wherein the wastewater outflow portion is provided in the upper circumference of the anoxic region as an overflow type.

7. The reactor according to claim 1, further comprising a bubble generating apparatus having an aeration tubes arranged in the lower side of the ciliary ball media assembly and an air supply device for supplying air to the aeration tube through an air supply tube, the bubble generating apparatus being capable of supplying the ciliary ball media assembly to bubbles and removing microorganism adhered to the ciliary ball media assembly.

8. The reactor according to claim 1, wherein the wastewater agitation device comprises a circulating pump arranged in the lower side of the anaerobic region; a wastewater rising tube connected to the circulating pump and extended to the upper side of the anaerobic region to guide the wastewater squeeze pumped by the circulating pump to the upper side of the anaerobic region; and a wastewater lowering tube connected to the upper end of the wastewater rising tube and extended to the lower side of the anaerobic region to guide the wastewater risen along the wastewater rising tube to the lower side of the anaerobic region.

9. The reactor according to claim 1, further comprising a nitrate solution transfer tube arranged in the lower side of the anoxic region to transfer the nitrate solution of the wastewater discharged through the wastewater outflow portion to anoxic region.

10. A water treatment apparatus comprising:
a composite microorganism reactor having an inner space for accommodating wastewater;
a sequencing batch reactor (SBR) having an aerobic tank and a sludge outlet and for executing the inflowing of wastewater, the microbial reaction, the precipitation and the discharging of wastewater in the same space, the wastewater passed through the composite microorganism reactor being flowed into the aerobic tank, the aerobic tank introducing air into the wastewater, and the sludge outlet discharging the precipitated sludge;
a filter module installed in the sequencing batch reactor, the filter module filtering and discharging the wastewater of the sequencing batch reactor; and
a nitrate solution transfer tank for receiving nitrate solution nitrified by executing aerobic process in the wastewater of the sequencing batch reactor, to reduce the concentration of dissolved oxygen of the nitrate solution,
wherein the composite microorganism reactor comprises:
a partition wall arranged in the inner space, for dividing the inner space into an anaerobic region and an anoxic region, the anaerobic region leading to dephosphorization by anaerobic mechanism of microorganism and the anoxic region leading to denitrification by anoxic mechanism of microorganism;
a wastewater inflow portion arranged in the upper side of the anaerobic region to introduce the wastewater into the anaerobic region;
a wastewater outflow portion arranged in the upper side of the anoxic region to discharge the wastewater of the anoxic region to the sequencing batch reactor;
a sludge outlet arranged in the lower side of the inner space to discharge the sludge precipitated in the wastewater introducing into the inner space; and
a wastewater agitation device installed in the anaerobic region to agitate the wastewater of the anaerobic region,
wherein the wastewater introducing into the anaerobic region through the wastewater inflow portion passes through the lower end of the partition wall to be introduced into the anoxic region, and then rises in the anoxic region to be flowed into the sequencing batch reactor through the wastewater outflow portion,
wherein the sludge discharged from the sludge outlet of the sequencing batch reactor is transferred to the anaerobic region and the nitrate solution of the nitrate solution transfer tank is transferred to the anoxic region.

11. The water treatment apparatus according to claim 10, further comprising a ciliary ball media assembly installed in the anoxic region of the composite microorganism reactor and made by connecting a plurality of ciliary ball media with a connecting member, facultative denitrification anaerobes being adhered to the plurality of ciliary ball media.

12. The water treatment apparatus according to claim 10, further comprising a ciliary ball media assembly installed in the sequencing batch reactor and made by connecting a plurality of ciliary ball media with a connecting member, facultative denitrification anaerobes being adhered to the plurality of ciliary ball media.

13. The water treatment apparatus according to claim 10, wherein the water treatment apparatus has a plurality of the sequencing batch reactors.

14. The water treatment apparatus according to claim 10, further comprising a filtration tank in which the wastewater passed through the sequencing batch reactor is introduced and a filtration device for separating and removing micro-pollution particles of the introduced wastewater is installed.

15. A water treatment apparatus comprising:
a composite microorganism reactor having an inner space for accommodating wastewater;
an aerobic tank in which the wastewater passed through the composite microorganism reactor is introduced and an aerobic device for introducing air into the wastewater is provided;
a precipitation tank in which the wastewater passed through the aerobic tank is introduced, the introduced wastewater is divided into a solid and liquid, and the upper water is discharged into a river and the precipitated sludge is discharged through a sludge discharge tube; and
a nitrate solution transfer tube for transferring the nitrate solution nitrified by executing aerobic process in the wastewater of the aerobic tank, to the composite microorganism reactor,
wherein the composite microorganism reactor comprises:
a partition wall arranged in the inner space, for dividing the inner space into an anaerobic region and an anoxic region, the anaerobic region leading to dephosphorization by anaerobic mechanism of microorganism and the anoxic region leading to denitrification by anoxic mechanism of microorganism;
a wastewater inflow portion arranged in the upper side of the anaerobic region to introduce the wastewater into the anaerobic region;
a wastewater outflow portion arranged in the upper side of the anoxic region to discharge the wastewater of the anoxic region to the aerobic tank;
a wastewater agitation device installed in the anaerobic region to agitate the wastewater of the anaerobic region,
wherein the wastewater introducing into the anaerobic region through the wastewater inflow portion passes through the lower end of the partition wall to be introduced into the anoxic region, and then rises in the anoxic region to be flowed to the aerobic tank through the wastewater outflow portion,
wherein the nitrate solution transferred through the nitrate solution transfer tube is transferred to the anoxic region, and
wherein a portion of the sludge discharged from the sludge outlet of the precipitation tank is transferred to the anaerobic region of the composite microorganism reactor.

16. The water treatment apparatus according to claim 15, further comprising a ciliary ball media assembly installed in the anoxic region of the composite microorganism reactor and made by connecting a plurality of ciliary ball media with a connecting member, facultative denitrification anaerobes being adhered to the plurality of ciliary ball media.

17. The water treatment apparatus according to claim 15, further comprising a ciliary ball media assembly installed in the aerobic tank and made by connecting a plurality of ciliary ball media with a connecting member, facultative denitrification anaerobes being adhered to the plurality of ciliary ball media.

18. The water treatment apparatus according to claim 15, wherein the composite microorganism reactor is installed in the aerobic tank.

19. A water treatment method, which comprises the steps of:
(a) inflowing wastewater into a composite microorganism reactor whose inner space is divided into an anaerobic region and an anoxic region by a partition wall, the anaerobic region leading to dephosphorization by anaerobic mechanism of microorganism and the anoxic region leading to denitrification by anoxic mechanism of microorganism, wherein the wastewater is introduced into the anaerobic region through a wastewater inflow portion arranged in the upper side of the anaerobic region and then flowed into the anoxic region through the lower end of the partition wall;
(b) inflowing the wastewater discharged from a wastewater outflow portion arranged in the upper side of the anoxic region into the sequencing batch reactor;
(c) introducing the nitrate solution nitrified by executing aerobic process in the wastewater of the sequencing batch reactor into the nitrate solution transfer tank to reduce the concentration of dissolved oxygen of the nitrate solution:
(d) transferring the nitrate solution of the nitrate solution transfer tank to the anoxic region of the composite microorganism tank;
(e) transferring the sludge precipitated in the sequencing batch reactor to the anaerobic region of the composite microorganism tank;
(f) discharging the sludge precipitated in the composite microorganism tank outside; and
(g) discharging the wastewater processed in the sequencing batch reactor outside.

20. The water treatment method according to claim 19, further comprising the step before the step (a), of installing a ciliary ball media assembly in the anoxic region of the composite microorganism reactor, the ciliary ball media assembly being made by connecting a plurality of ciliary ball media with a connecting member, and facultative denitrification anaerobes being adhered to the plurality of ciliary ball media.

21. The water treatment method according to claim 20, further comprising the step after the step (g), of separating and removing micro-pollution particles of the wastewater discharged from the sequencing batch reactor by using a filtration device.

22. A water treatment method, which comprises the steps of:
(a) inflowing wastewater into a composite microorganism reactor whose inner space is divided into an anaerobic region and an anoxic region by a partition wall, the anaerobic region leading to dephosphorization and the anoxic region leading to denitrification, wherein the wastewater is introduced into the anaerobic region through a wastewater inflow portion arranged in the upper side of the anaerobic region and then flowed into the anoxic region through the lower end of the partition wall;
(b) inflowing the wastewater discharged from a wastewater outflow portion arranged in the upper side of the anoxic region into the aerobic tank;
(c) transferring the nitrate solution nitrified by executing aerobic process in the wastewater of the aerobic tank to the anoxic region of the composite microorganism tank;
(d) precipitating and filtering the wastewater processed in the aerobic tank, which is introduced into a precipitation tank;
(e) transferring the sludge precipitated in the precipitation tank to the anaerobic region of the composite microorganism tank; and
(f) discharging the wastewater processed in the precipitation outside.

23. The water treatment method according to claim 22, further comprising the step before the step (a), of installing a ciliary ball media assembly in the anoxic region of the composite microorganism reactor, the ciliary ball media assembly being made by connecting a plurality of ciliary ball media with a connecting member, and facultative denitrification anaerobes being adhered to the plurality of ciliary ball media.
